(19) United States
(12) Patent Application Publication
(10) Pub. No.: US 2008/0093937 A1
(43) Pub. Date: Apr. 24, 2008

(54) Electrical Machine

(75) Inventors: Wolfgang Winkler, Schutterwald (DE); Markus Heidrich, Buehl (DE); Hans-Peter Seebacher, Baden-Baden (DE); Fernando Silva, Buehl (DE); Christian Ernst, Sasbach (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: ROBERT BOSCH GMBH, Stuttgart (DE)

(21) Appl. No.: 11/575,712

(22) PCT Filed: Aug. 17, 2005
(86) PCT No.: PCT/EP05/54063

§ 371 Date: Aug. 29, 2007

(30) Foreign Application Priority Data
Sep. 21, 2004 (DE) 10 2004 045 626.7

(51) Int. Cl. H02K 5/16; H02K 15/16; H02K 5/15

(52) U.S. Cl. 310/42; 310/90; 310/89; 29/525; 29/718; 29/598

(57) ABSTRACT

An electrical machine, preferably a blower drive mechanism for a motor vehicle, having a shaft which is supported in at least two bearings with a specified axial play; a cylindrical bearing is secured in a bearing seat of an end shield and rests directly on the bearing seat. The cylindrical bearing has a cylindrical outer circumference, and the bearing seat is a sleeve with a cylindrical inside diameter, into which sleeve the cylindrical bearing is secured with a press fit on the outer circumference and is held axially in the bearing seat by the thus-attained frictional engagement. This has the advantage that more-precise adjustment of the longitudinal play of the armature is possible. Moreover, no additional components such as retaining springs are necessary.

### PRIOR ART

The invention is based on an electrical machine as generically defined by the preamble to claim 1.

An electrical machine of this kind, such as a blower drive mechanism for a motor vehicle, includes a, which is placed with axial play in at least two bearings, and at least one bearing is secured in a bearing seat of an end shield and rests directly on the bearing seat.

In electric motors of the kind that are typically used for heater and air conditioner motors, stringent demands are made with regard to the longitudinal armature play. The axial play, which should amount to 0.1 to 0.3 mm, for instance, is an essential variable for assuring the function of the electric motor. The primary task is to keep a certain axial play between the bearings and the armature free, in order to cover a temperature range of from −40° C. to +80° C. The axial play should, however, not be too great, since that has an adverse effect on noise or the vibration behavior (so-called axial vibration) and the service life of the motor.

Typically, the longitudinal armature play between two spherical bearings for heater and air conditioner motors is realized via the axial re-pressing of the end shield or the displacement of the end shield with additional wedging. It is also known to adjust the axial play in electric motors by inserting disks of various thicknesses between rotating and stationary parts. To that end, the actual play must be measured and adjusted or compensated for by a suitable number of disks of difference thicknesses. Finally, it is also known, for instance in geared motors, to adjust the axial play by rotating an axial adjusting screw in a gearbox.

### ADVANTAGES OF THE INVENTION

The electrical machine of the invention, having the definitive characteristics of claim 1, has the advantage that more-precise adjustment of the longitudinal armature play is possible. No additional components, such as retaining springs, are needed. No addition processes or process stations, for instance for the wedging, repeated testing, and so forth are necessary. Moreover, because the number of parts is reduced, the construction of the motor is simpler. To that end, an electrical machine, preferably a blower drive mechanism for a motor vehicle, is provided, having a shaft which is supported with axial play in at least two bearings, and at least one bearing is secured in a bearing seat of an end shield and rests directly on the bearing seat, wherein the at least bearing is a cylindrical bearing with a cylindrical outer circumference; and that the bearing seat is a sleeve having a cylindrical inside diameter, into which sleeve the cylindrical bearing is secured on the outer circumference with a press fit and is retained axially in the bearing seat by the thus-attained frictional engagement.

Preferably, the end shield has an outer edge, which is located on, and preferably rolled into, a pole ring of the electrical machine, and the outer edge is adjoined by a curved region, which protrudes from the pole ring of the electrical machine, and the sleeve is disposed in the curved region. This provides great strength of the combination in the axial direction, with easy production. The strength in the axial direction is increased if the end shield has at least one reinforcement for increasing the axial rigidity. Such a reinforcement can easily be produced in that at least the curved region has reinforcing beads, which preferably extend in the radial direction. Production is further simplified if the end shield a stamped and bent part.

If the sleeve protrudes into the electrical machine, then the curved region can be axially more rigid for the same height, and as a result the strength is increased. If the sleeve protrudes from the electrical machine, then the curved region can be designed more shallowly, making excellent utilization of the available volume possible, for instance for a fan wheel.

Because the cylindrical bearing is a sintered bearing, the axial play can be utilized quite simply, since unlike in a roller bearing, there is no risk of fitting corrosion.

Because stop disks are disposed on the shaft, axially between a respective bearing and an armature packet, an armature and/or a commutator for instance are well protected against lubricant that might run out. The stop disks may also contribute somewhat to damping and thus to quieter operation.

Because a second end shield, which is diametrically opposite the end shield having the cylindrical bearing, is secured in a pole ring of the electrical machine, and the second end shield has at least two brackets, protruding from the bearing seat for the bearing; because tabs on the brackets protrude outward and are inserted into recesses in the pole ring; and because next to the tabs, diametrically opposed stops are embodied, which are disposed inside the pole ring and whose diametral spacing is less than the inside diameter of the pole ring, so that the second end shield is supported in floating fashion before assembly, the bearings can easily be axially aligned. The risk of rough operation is minimized.

Furthermore, a method for adjusting the axial play of the shaft of such an electrical machine is provided, in which the electrical machine is installed with an axial play that is greater than the specified axial play; the electrical machine is fixed; the shaft is pressed against one of the bearings; the shaft is then displaced in the direction of the other bearing, and the displacement distance until the shaft is pressed against the other bearing is measured; and the cylindrical bearing is pressed in the direction of the other bearing until the specified axial play is reached.

Because the shaft is pressed against the one bearing with a force which compresses a stop disk, disposed there; because the shaft is then pressed with a force against the other bearing that also compresses a stop disk disposed there; and because the two dimensions by which the stop disks are compressed are added to the displacement distance, the axial play can be adjusted even more precisely, since these elastic components of the stop disks are included in the process.

Because a dimension by which the end shield, in which the cylindrical bearing is located, bends at least elastically upon pressing in of the cylindrical bearing is ascertained; and because the cylindrical bearing is additionally pressed by this dimension farther into the bearing seat, the axial play can be adjusted still more precisely.

If the shaft, after the adjustment of the axial play, is again pressed against one of the bearings and is then displaced in the direction of the other bearing, and the displacement distance until the shaft is pressed against the other bearing is measured again, and the re-measured displacement distance is compared with a predetermined value, then quality control can also be performed at the same station, making it possible to dispense with one subsequent station. If the re-measured displacement distance is too great, the method for adjusting the axial play is simply repeated.

If the bearings of the electrical machine are not aligned quite precisely, it can happen that the shaft runs roughly. To prevent this, it is proposed that after the connection of the pole ring and the end shield that has the cylindrical bearing, the shaft is put in place, and after that an end shield, which is diametrically opposite the end shield of the cylindrical bearing, is placed upon assembly into the pole ring with radial play and is thrust onto the shaft, so that the end shield is aligned, and only then is it wedged to the pole ring.

An apparatus for performing the method includes a device for displacing the cylindrical bearing, onto which device the shaft is slipped and which device rests on the cylindrical bearing; a journal, which is disposed in the device, for displacing the shaft away from the cylindrical bearing; a holder for retaining the electrical machine; a journal for displacing the shaft counter to the cylindrical bearing; and a measuring device for measuring the axial play.

Further advantages and advantageous refinements will become apparent from the dependent claims and the description.

### DRAWINGS

One exemplary embodiment is shown in the drawings and described in further detail in the ensuing description. Shown are:

FIG. 1, an electrical machine in a longitudinal section;

FIG. 2, the electrical machine in a perspective view;

FIG. 3, a bearing bracket of the electrical machine;

FIG. 4, the electrical machine with a modified end shield;

FIG. 5, the modified end shield; and

FIG. 6, a further modified end shield.

### DESCRIPTION OF THE EXEMPLARY EMBODIMENT

In FIG. 1, a rotating electrical machine is shown in simplified form in a longitudinal section. The electrical machine is an electric motor 10, which is used in a motor vehicle, for instance in a power window system, a wiper drive mechanism, or preferably a heater and/or blower drive mechanism, and so forth. However, it may also be a generator.

The electric motor 10 has a wound armature 12, which is disposed on a shaft 14. The armature 12 is connected to a commutator 16, which is connected by brushes 18 of a brush holder 20. Instead of the commutator 16, a collector of a generator may be provided.

The shaft 14 is supported in a spherical bearing 22 and a cylindrical bearing 24. In the present exemplary embodiment, the bearings 22, 24 are sintered bearings or slide bearings, which are saturated with oil. The spherical bearing 22 is disposed on a bearing bracket 26 in the region of the brush holder 20. The cylindrical bearing 24 is disposed on the power takeoff side in an end shield 28.1. The bearing bracket 26 and the end shield 28.1 are in turn disposed on the two face ends of a pole ring 30.

A stop disk 32 with a receiving bore 34 for the shaft 14 is disposed on the shaft 14, between the bearing 22 and the commutator 16. A further stop disk 32 is disposed between the other bearing 24 and the armature 12, or some other component, such as a sleeve, the collar of an insulating lamination, and so forth. However, this stop disk may also be omitted, or a differently shaped stop disk may be provided.

It is important that the shaft 14, by means of the bearings 22, 24, have a specified axial play. The specified axial play should be only as great as necessary, to permit temperature-dictated changes in length of the components; it should be as slight as possible, so that the shaft cannot execute any overly great axial motions. It is therefore possible only with difficulty to use roller bearings, since because of the axial play, a relative motion would be possible between rotating and moving parts, which would lead to fitting corrosion.

The end shield 28.1 on the power takeoff side has a bearing seat, protruding into the electric motor 10, in the form of a first sleeve 36.1 for the cylindrical bearing 24, which sleeve is provided with a cylindrical inside diameter. The cylindrical bearing 24 is secured to the outer circumference via a press fit and is held axially in the bearing seat by the thus-attained frictional engagement. Thus the cylindrical bearing 24 rests directly on the inside diameter of the bearing seat, without the interposition of a suspension means as is the case for instance with spherical bearings. Optionally, axial fittings or a stop may be provided. Essentially and preferably exclusively, however, the cylindrical bearing 24 is retained by the press fit.

An annular curved region 38 is embodied around the sleeve 36.1 and protrudes out of the pole ring 30 of the electric motor 10. A disklike outer edge 40 is embodied around the curved region 38. With this edge 40, the end shield 28.1 is secured to the pole ring 30. Preferably, the edge 40 is rolled into a groove 42 of the pole ring 30. The end shield 28.1 may, however, also be embodied integrally with the pole ring 30. That is possible for instance by providing that the pole ring 30 is deep-drawn along with what is then the integrally embodied end shield 28.1. However, the rolled-in variant can be produced more economically. In that case, the pole ring 30 is preferably rolled. The end shield 28.1 is a stamped and bent part, and the sleeve 36.1 is deep-drawn.

The end shield 28.1 has reinforcements for increasing the axial rigidity. To that end, reinforcing beads which preferably extend in the radial direction are embodied in the curved region 38. This will be discussed in further detail hereinafter.

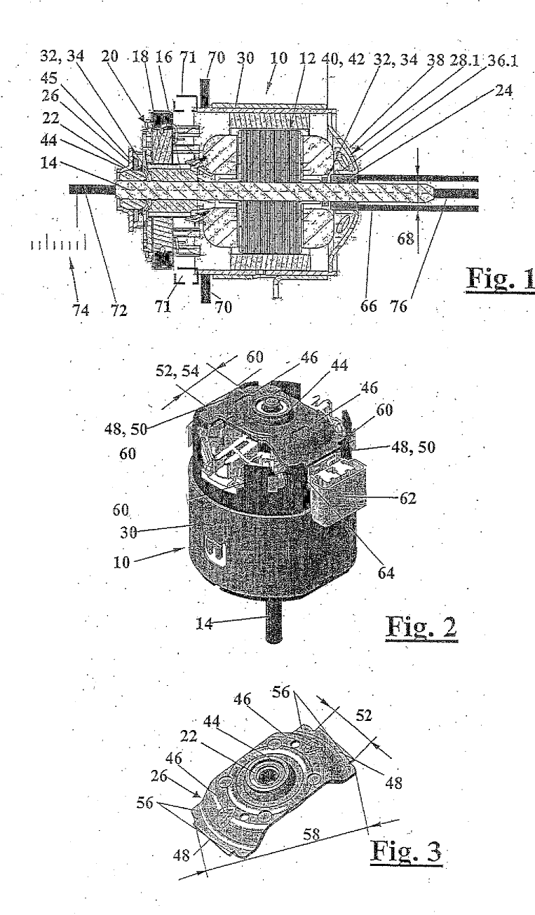

In FIG. 2, a perspective view of the electric motor 10 is shown, in which details of the bearing bracket 26, disposed in the region of the brush holder 20, are shown more clearly. In FIG. 3, the bearing bracket 26 is show by itself.

The bearing bracket 26, which is diametrically opposite the end shield 28.1 having the cylindrical bearing 24, is secured to the pole ring 30. The bearing bracket 26 includes a spherical bearing seat 44 for the spherical bearing 22. The spherical bearing 22 is retained on the bearing bracket 26 via a clamping bracelet 45 (FIG. 1). Two brackets 46 protrude from the bearing seat 44. It is also possible for more than two brackets 46 to be provided. The bearing bracket 26 may also be embodied around the bearing seat 44, like the end shield 28.1. In both cases, the bearing bracket 26 can generally be called an end shield.

Tabs 48 protrude from the brackets 46 and are inserted into recesses 50 in the pole ring 30. The tabs 48 have a width 52, which is less than the width 54 of the recesses. This involves a range of from 0.1 to 0.3 mm.

Next to the tabs 48, diametrically opposed edges 56 are embodied, past which the tabs 48 protrude, so that they can be disposed in the recesses 50. The edges 56 have a lesser diametral spacing 58 than the tabs 48. However, the diametral spacing 56 is less than the inside diameter 30 of the pole ring 30. As a result, they are disposed in the inside diameter of the pole ring 30. As a consequence, the bearing bracket 26 is supported in floating fashion before assembly. The floating support is important for an assembly in which the shaft 14 remains smoothly running. This will be addressed in further detail hereinafter.

Finally, the electric motor 10 also has a connection plug 62, which is connected or integrally joined to the brush holder 20. This plug is placed in a window 64 in the pole ring 30. The window 64 is a recess, beginning at least one of the two diametrically opposed recesses 50, that is preferably somewhat narrower than the recess 50. The plug is then secured in its position by one of the two tabs 48 placed in the recess 50.

When the end shield 28.1 is put together, the cylindrical bearing 24 is pressed into the sleeve 36.1, or the bearing seat of the end shield 28.1, only far enough that the axial play after the installation of the other components and groups of components is greater than the axial play that is wanted after production is complete.

In the further assembly of the electric motor 10, first the pole ring 30 and the end shield 28.1 are connected by providing that the edge 40 is rolled into the groove 42. This is unnecessary if the pole ring 30 and the end shield 28.1 are deep-drawn. After that, the armature 12 with the shaft 14 and the stop disk 32, slipped onto it previously, is inserted, and the shaft 14 is inserted into the cylindrical bearing 26.

In the next step, the brush holder is secured to the pole ring 30. Next, the bearing bracket 26 with the spherical bearing 24 is slipped onto the shaft 14. The tabs 48 are placed in the groovelike recesses 50. The edges 56 are located inside the pole ring 30. The bearing bracket 26 now, because of the floating support, has radial play when it rests on the pole ring 30. This is due to the fact that, as already described above, the spacing 58 of the edges 56 is somewhat less than the inside diameter of the pole ring 30, and the width 52 of the tabs 48 is somewhat less than the width 54 of the recesses 50. As a result, the bearing bracket 26 can radially align itself when it is slipped onto the shaft 14. The spherical bearing 22 and the cylindrical bearing 24 are thus aligned with one another. The bearing bracket 26 is then fixed in its position with a holding-down device. Next, the edges 60 of the recesses 50 are wedged, so that they rest laterally somewhat above the tabs 48 and retain the tabs by positive engagement. It is also possible to employ closer production tolerances, without the floating support. As a rule, however, it is favorable to employ the floating support, because it is then not necessary to specify such close production tolerances.

For adjusting the axial play of the shaft 14, the electric motor 10 is next placed, with the shaft 14 leading, onto a tube 66. The electric motor 10 is preferably vertically onto the tube 66, whereupon the cylindrical bearing 24 is oriented downward. The outside diameter 68 of the tube 66 is if at all possible somewhat less than the inside diameter of the sleeve 36.1. The electric motor 10 is then firmly held or fixed with lateral grippers 70 or holding-down devices of an NC joining module. Next, a journal 72 moves from above against the shaft 14 in such a way that the shaft 14 is pressed with a predetermined force against the cylindrical bearing 24. The journal 72 is coupled with a length measuring device 74 that is shown in simplified form.

Now a journal 76 moves against the shaft 14 from below and pushes it in the direction of the spherical bearing 22, until it is pressed against the spherical bearing 22. In the process, the displacement distance is measured with the length measuring device 74 that is coupled to the journal 72.

The shaft 14 is pressed against the cylindrical bearing 24 preferably with a force which compresses the stop disk 32 somewhat. The shaft 14 is also pressed against the spherical bearing 22 with a force which slightly compresses the stop disk 32 there. In both cases, this is done to such an extent that the elasticity of the stop disks 32 is also taken into account. The two dimensions by which the stop disks 32 are compressed are added to the displacement distance.

Preferably, a dimension is also ascertained by which the end shield 28.1 in which the cylindrical bearing 24 is disposed bends at least elastically when the cylindrical bearing 24 is pressed in. The cylindrical bearing 24 is likewise pressed at least partway farther into the sleeve 36.1 by this dimension.

A measuring sensor which is set to 0 when the shaft 14 is moved against the cylindrical bearing 24 can be connected to the journal 72. When the shaft 14 or the armature 12 is thrust upward with a defined force, the thus-ascertained actual value is forwarded directly to the controller of the displacement mechanism in the form of the tube 66, which is coupled with a controller of an NC joining module, and calculated. After this measurement process, the journal 72 still remains approached by the length measuring device 74. In the next process step, this journal now has the task of forming a closed circuit with the controller. In the next step, the NC joining module, via a scanning function, moves flush against the face end of the cylindrical bearing, the blocking force being approximately 150 N, and stores this absolute position in memory and then displaces the cylindrical bearing 24, with a displacement force of approximately 1 kN, in a regulated way via the external measurement simulator of the length measuring device 74, to the desired position. A further regulating mechanism is provided by a rigidity mode in the NC controller of the joining module for compensating, as already described, for the sagging of the end shield 28.1.

It is also possible for the tube 66 and thus the cylindrical bearing 24 to be stationary and for the pole ring 30 to be displaced in the direction of the cylindrical bearing 24. This can be done by the grippers 70 or holding-down devices of the NC Joining module. What is important is that the pole ring 30 and the cylindrical bearing 24 are displaced relative to one another, in order to adjust the desired axial play. It is also possible that instead of the grippers 70, which engage the pole ring laterally, a plurality of bolts 71 or a tube may engage the face end of the pole ring 30 facing away from the cylindrical bearing 24 and displace the pole ring. As a result, no radial force is exerted on the pole ring 30.

If a dimension of 0.5 mm is measured for instance as the first displacement distance, then the cylindrical bearing 24 is displaced by 0.4 mm, which should yield a resultant axial play of 0.1 mm. However, since the stop disk 32 and the end shield 28.1 yield somewhat in the elastic range, an axial play of 0.15 mm, for instance, then results.

After the adjustment of the axial play, the shaft 14 is pressed again against the cylindrical bearing 24. After that, the shaft 14 is pressed again against the spherical bearing 22, and the displacement distance is measured again. The re-measured displacement distance is compared with a predetermined value. If the re-measured displacement distance is too great, the method for adjusting the axial play is performed over again.

Instead of the displacement described, in which the shaft 14 is first pressed against the cylindrical bearing 24 and then against the spherical bearing 22, these operations can naturally be done in reverse order. Nor does the cylindrical bearing 24 have to be oriented downward; it may be oriented upward or laterally. Only the operative forces of gravity need to be taken into account accordingly.

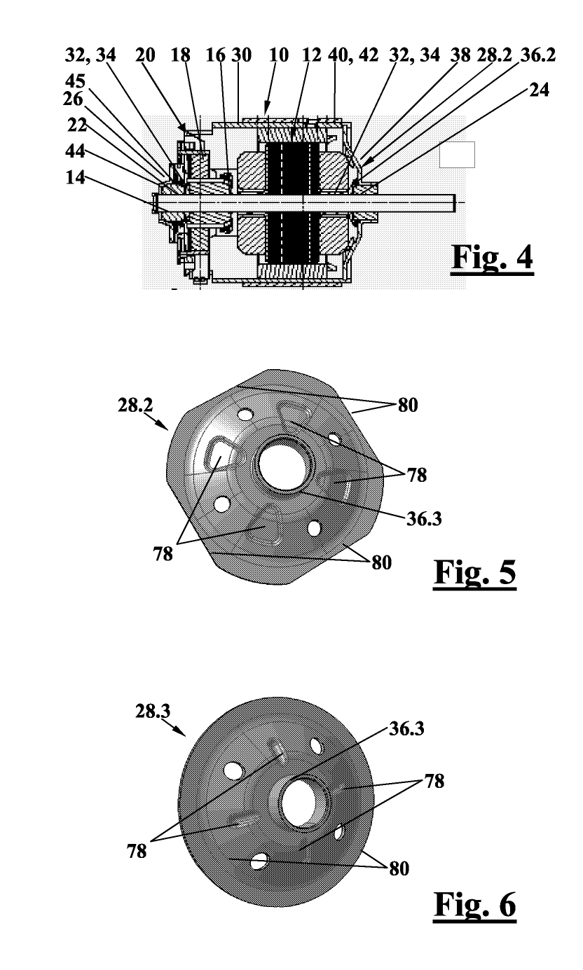

In FIG. 4, the electric motor 10 is shown with a modified end shield 28.2. A sleeve 36.2 protrudes from the electric motor 10 or from the pole ring 30. The other components and groups of components have the same reference numerals as described for FIGS. 1, 2 and 3. Accordingly, see those passages.

The end shield 28.2 is more clearly visible in FIG. 5, and the beads 78 already described are also visible. The end shield 28.2 is not circular but instead has four flat faces 80. As a result, the pole ring 30 can be flattened as shown in FIG. 2, so less installation space is required. Pairs of diametrically opposed flat faces 80 have the same spacing from one another. This allows the end shield 28.2 to be installed more variably.

As the final variant, a circular end shield 28.3 is shown in FIG. 6. The end shields 28 may, however, be embodied as bearing brackets.

With the method described, it is possible to adjust the longitudinal armature play functionally appropriately via the axial displacement of the cylindrical bearing 24, and to do so in one work process without additional processes such as wedging and without further components. The prerequisite for this is the structural design of the support with the cylindrical bearing 24. The design of the fit of the bearing combination and the concentricity of the bearing seats have an influence on the strength and the displacement force upon further pressing of the cylindrical bearing 24 during the adjustment process. The demand made of the end shield 28 with regard to rigidity in the axial direction, or in other words the pressing direction, is also important, since the elastic deformation and sagging upon the initiation of axial force can likewise be incorporated into the measurement of the longitudinal play.

An apparatus for performing the method described thus includes a device 66 for displacing the cylindrical bearing 24, which device rests on the cylindrical bearing 24 and onto which device the shaft 14 is slipped; a journal 76, for displacing the shaft 14 away from the cylindrical bearing 24; a holder 70, for retaining at least the electric motor 10; a journal 72, for displacing the shaft 14 counter to the cylindrical bearing 24; and a device 74 for measuring the axial play.

1-16. (canceled)

17. In an electrical machine having a shaft which is supported with axial play in at least two bearings, and at least one bearing is secured in a bearing seat of an end shield and rests directly on the bearing seat, the improvement wherein the at least one bearing is a cylindrical bearing with a cylindrical outer circumference; and wherein the bearing seat is a sleeve having a cylindrical inside diameter, into which sleeve the cylindrical bearing is secured on the outer circumference with a press fit and is retained axially in the bearing seat by the thus-attained frictional engagement.

18. The electrical machine as defined by claim 17, wherein the end shield has an outer edge, which is located in a pole ring of the electrical machine; wherein the outer edge is adjoined by a curved region which protrudes from the pole ring of the electrical machine; and wherein the sleeve is disposed in the curved region.

19. The electrical machine as defined by claim 18, wherein the outer edge of the end shield is rolled into the pole ring.

20. The electrical machine as defined by claim 17, wherein the end shield has at least one reinforcement for increasing the axial rigidity.

21. The electrical machine as defined by claim 18, wherein at least the curved region has reinforcing beads extending in a generally radial direction.

22. The electrical machine as defined by claim 18, wherein the end shield is a stamped and bent part.

23. The electrical machine as defined by claim 17, wherein the sleeve protrudes into the electrical machine or protrudes out of the electrical machine.

24. The electrical machine as defined by claim 17, wherein the cylindrical bearing is a sintered bearing.

25. The electrical machine as defined by claim 17, further comprising stop disks disposed on the shaft, axially between a respective bearing and an armature packet.

26. The electrical machine as defined by claim 17, further comprising a second end shield diametrically opposite the end shield having the cylindrical bearing, the second end shield being secured in a pole ring of the electrical machine and having a bearing seat for the spherical bearing and at least two brackets protruding from its bearing seat, tabs protruding outward from the outer circumference of the end second shield and inserted into recesses in the pole ring, and diametrically opposed stops next to the tabs which stops are disposed inside the pole ring and whose diametral spacing is less than the inside diameter of the pole ring.

27. A method for adjusting the axial play of the shaft of an electrical machine as defined by claim 17, the method comprising the steps or installing the electrical machine with an axial play of the shaft that is greater than the specified axial play; pressing the shaft against one of the bearings; displacing the shaft in the direction of the other bearing and measuring the displacement distance until the shaft is pressed against the other bearing; and pressing the one bearing in the direction of the other bearing until the specified axial play is reached.

28. The method as defined by claim 27, further comprising first pressing the shaft against the one bearing with a force which compresses a stop disk disposed there; then pressing the shaft with a force against the other bearing that also compresses a stop disk disposed there; and adding the two dimensions by which the stop disks are compressed to the displacement distance.

29. The method as defined by claim 27, further comprising ascertaining a dimension by which the end shield in which the cylindrical bearing is located, bends at least elastically upon pressing in of the cylindrical bearing; and pressing the cylindrical bearing additionally by this dimension farther into the bearing seat.

30. The method as defined by claim 28, further comprising ascertaining a dimension by which the end shield in which the cylindrical bearing is located, bends at least elastically upon pressing in of the cylindrical bearing; and pressing the cylindrical bearing additionally by this dimension farther into the bearing seat.

31. The method as defined by claim 27, further comprising again pressing the shaft against one of the bearings after the adjustment of the axial play; then displacing the shaft in the direction of the other bearing, and measuring the displacement distance until the shaft is pressed against the other bearing again; and the re-measured displacement distance with a predetermined value.

32. The method as defined by claim 28, further comprising again pressing the shaft against one of the bearings after the adjustment of the axial play; then displacing the shaft in the direction of the other bearing, and measuring the displacement distance until the shaft is pressed against the other bearing again; and the re-measured displacement distance with a predetermined value.

33. The method as defined by claim 29, further comprising again pressing the shaft against one of the bearings after the adjustment of the axial play; then displacing the shaft in the direction of the other bearing, and measuring the displacement distance until the shaft is pressed against the other bearing again; and the re-measured displacement distance with a predetermined value.

34. The method as defined by claim 31, further comprising repeating the method if the re-measured displacement distance is too great.

35. The method as defined by claim 27, further comprising putting the shaft in place after the connection of the pole ring and the end shield that has the cylindrical bearing, and after that a second end shield, which is diametrically opposite the end shield of the cylindrical bearing, is placed upon assembly into the pole ring with radial play and is thrust onto the shaft, so that the end shield is aligned, and is then wedged to the pole ring.

36. An apparatus for performing the method as defined by claim 26, the apparatus comprising a device for displacing the cylindrical bearing, which device rests on the cylindrical bearing and onto which device the shaft is slipped; a journal, for displacing the shaft away from the cylindrical bearing; a holder, for retaining at least the electrical machine; a journal, for displacing the shaft counter to the cylindrical bearing; and a device for measuring the axial play.
